(19) United States
(12) Patent Application Publication
(10) Pub. No.: US 2025/0296415 A1
(43) Pub. Date: Sep. 25, 2025

(54) Bendable Seal For A Motor Vehicle, And Method For Manufacturing Same

(71) Applicant: Cooper-Standard France, Vitre Cedex (FR)

(72) Inventors: Romain Sartoni, Domalain (FR); Désiré Le Dissez, Pire-Sur-Seiche (FR)

(73) Assignee: Cooper-Standard France, Vitre Cedex (FR)

(21) Appl. No.: 18/860,931

(22) PCT Filed: Apr. 27, 2023
(86) PCT No.: PCT/EP2023/061186

§ 371 Date: Oct. 28, 2024

(30) Foreign Application Priority Data
Apr. 29, 2022 (FR) FR2204108

(51) Int. Cl. B60J 10/84; B60J 10/16; B60J 10/22; B60J 10/24

(52) U.S. Cl. CPC B60J 10/84; B60J 10/16; B60J 10/22; B60J 10/24

(57) ABSTRACT

A seal for a motor vehicle includes a longitudinal profile, which is made of rigid thermoplastic material, and at least one element made of elastomer material. The longitudinal profile includes a bottom and two lateral longitudinal branches, wherein the longitudinal profile includes, over at least part of its length, at least one bendable portion with a corrugated structure, wherein the corrugated-structure portion extends at least along one of the two longitudinal connection regions which respectively extend between the bottom and one of the two lateral branches, and wherein the corrugated-structure portion includes a continuous succession of corrugations, without material discontinuity, the parallel planes of the parallel grooves of the various corrugations being oriented perpendicularly or substantially perpendicularly to the longitudinal axis of the longitudinal profile.

### FIELD OF THE INVENTION

The invention relates to the field of motor vehicle equipment, such as in particular cars, trucks or tractors.

The present invention relates more specifically to a bendable seal for a motor vehicle, intended to be positioned for example at the apertures in the bodywork or on the door-leafs (doors, hood and trunk) of a motor vehicle and more specifically, on rebates formed on these apertures or these door-leafs.

The invention also relates to a method for manufacturing this seal.

### STATE OF THE ART

Such seals are already known from the prior art, which comprise a central metal frame, around which a material, for example EPDM, is coextruded. Such a metal frame has an openwork structure with a succession of solid and openwork structures, of the “fishbone” type.

However, new economic and ecological challenges, related to the reduction of the weight of vehicles and the recyclability of their components, require the development of lighter seals that can be more easily recycled, in particular by removing the initial metal frames.

In addition, such a seal must have sufficient flexibility to be able to be bent and mounted on a rounded rebate of a body (radius grip), and must also be able to be retained on the rebate and not detach therefrom over a wide range of vehicle operating temperatures.

Also known from document EP 3 409 522 is a seal for a motor vehicle. However, this seal does not comprise a longitudinal profile with an open cross-section, made of rigid thermoplastic material and comprising corrugations whose concavity is oriented towards the inside of the longitudinal profile.

It follows that this seal does not simultaneously ensure good flexibility to fit the shape of the support on which it is intended to be placed and good clamping of this support to be correctly retained thereon.

### DISCLOSURE OF THE INVENTION

The purpose invention is therefore to propose a seal for a motor vehicle which is lighter and more easily recyclable than those of the prior art, which can be applied to rebates, including those having a small radius of curvature and finally, which can clamp the rebate and be retained thereon, over the usual operating ranges of the vehicle (that is to say generally between −30° C. and 85° C.).

For this purpose, the invention relates to a bendable seal for a motor vehicle comprising a longitudinal profile configured to be positioned on a support of the motor vehicle, such as a rebate, and at least one element made of elastomer material, selected from a longitudinal sealing lip and a support pad, said longitudinal profile having an open cross-section and comprising a bottom and two lateral longitudinal branches which respectively extend from this bottom and on either side thereof, such that the bottom and the two branches together form a clamp and delimit a longitudinal cavity, opening opposite the bottom, said element made of elastomer material projecting from this longitudinal profile towards the inside of said longitudinal cavity.

In accordance with the invention, said longitudinal profile is made of rigid thermoplastic material and comprises, over at least part of its length, at least one bendable portion with a corrugated structure, this corrugated-structure portion comprises a continuous succession of corrugations, without material discontinuity, these corrugations being made up of a continuous alternation of bridges and junction parts, each bridge having a back which is extended by two legs, the concavity of the bridge being oriented towards the inside of the longitudinal profile and each junction part joining the inner end of a leg of a bridge to the inner end of a leg of the neighboring bridge, this corrugated-structure portion extends at least along one of the two longitudinal connection regions which respectively extend between the bottom and one of the two lateral branches and between the bottom and the other of the two lateral branches of the longitudinal profile and the parallel planes of the parallel grooves of the various corrugations are oriented perpendicularly or substantially perpendicularly to the longitudinal axis of said longitudinal profile.

Thanks to these features of the invention, there is a synergistic effect between the two branches of the profile and the corrugations of the corrugated-structure portion which contributes to reinforcing the clamping effect of the profile and the overall retention of the seal when the latter is disposed on a support of the motor vehicle, such as a rebate.

Furthermore, the corrugated structure gives the seal its bendable character both along the longitudinal axis of the profile and laterally, so that it can, for example, follow the curved or sinusoidal shape of the support of the motor vehicle on which it is intended to be placed.

In addition, the choice of materials makes the seal lighter than those containing a metal frame and more easily recyclable.

Finally, the elastomer material element which projects into the longitudinal cavity of the seal further reinforces the retention of the seal when it is placed on the rebate.

According to other advantageous and non-limiting features of the invention, taken alone or in combination:
the longitudinal profile comprises at least one portion called “smooth” portion, free from any corrugated structure.
the seal comprises, over at least part of the length of the longitudinal profile, an alternation of portions with a corrugated structure and with an open cross-section and of smooth portions with an open cross-section.
the seal comprises over at least part of the length of said longitudinal profile, a smooth portion which extends over at least part of the width of said bottom, and corrugated-structure portions which extend over the two lateral branches of the longitudinal profile.
the seal comprises over at least part of the length of said longitudinal profile, a smooth portion which extends over at least part of the height of at least one of the two lateral branches and a corrugated-structure portion which extends over the width of said bottom.
said at least one element made of elastomer material is coextruded onto the longitudinal profile.
said longitudinal profile comprises at least one longitudinal damping tube made of elastomer material which projects outwards from the bottom or from one of the two lateral branches and this longitudinal damping tube is coextruded on said longitudinal profile.
said longitudinal profile is covered with a sheathing sleeve, coextruded on said profile and in that said longitudinal sealing lip and/or said support pad is made in one piece with said sleeve.
the sheathing sleeve further comprises at least one longitudinal damping tube which projects outwards from this sleeve.
the depth of a corrugation at the free end of one of the two branches or of both branches is equal to or greater than the depth of this same corrugation in the bottom part of the longitudinal profile.
the thickness of the thermoplastic material constituting the longitudinal profile is less in the two lateral branches than in the bottom and decreases towards the free end of said branches.
the portion with a corrugated structure extends over the entire longitudinal profile and in that said longitudinal profile is provided with a longitudinal rib which projects outwards.
the outer face of the back and/or the inner face of the junction part of the corrugations is flat.

The invention also relates to a method for manufacturing the aforementioned seal.

In accordance with the invention, this method comprises the steps:
extruding a hollow initial longitudinal profile with a closed cross-section made of rigid thermoplastic material,
forming on at least part of this initial profile at least one bendable portion with a corrugated structure, so as to obtain a corrugated profile,
axially cutting this corrugated profile to obtain two longitudinal profiles with an open cross-section,
coextruding at least one element made of elastomer material, such as a longitudinal sealing lip or a support pad, so as to obtain said bendable seal.

According to other advantageous and non-limiting features of the invention, taken alone or in combination:
the coextrusion of said at least one element made of elastomer material is carried out simultaneously with the extrusion of the initial longitudinal profile.
the coextrusion of said at least one element made of elastomer material is carried out after the cutting step, on the longitudinal profile with open section.

### DESCRIPTION OF THE FIGURES

Other features, purposes and advantages of the invention will emerge from the description which follows, which is purely illustrative and non-limiting, and which must be read in conjunction with the appended drawings in which:

FIG. 1 is a perspective view of a first embodiment of an automotive seal in accordance with the invention.

FIG. 2 is a detailed and longitudinal sectional view of the seal, taken along the section plane P2 of FIG. 1.

FIG. 3 is a detailed and longitudinal sectional view of the seal, taken along the section plane P3 of FIG. 1.

FIG. 4 is a perspective view of a first variant of shape of the longitudinal profile of a seal in accordance with the invention.

FIG. 5 is a perspective view of a second variant of shape of the longitudinal profile of a seal in accordance with the invention.

FIG. 6 is a perspective view of a third variant of shape of the longitudinal profile of a seal in accordance with the invention.

FIG. 7 is a perspective view of a fourth variant of shape of the longitudinal profile of a seal in accordance with the invention.

FIG. 8 is a perspective view of a second embodiment of an automotive seal in accordance with the invention.

FIG. 9 is a perspective view of a third embodiment of an automotive seal in accordance with the invention.

FIG. 10 is a perspective view of a fourth embodiment of an automotive seal in accordance with the invention.

FIG. 11 is a perspective view of a fifth embodiment of an automotive seal in accordance with the invention.

FIG. 12 is a perspective view of a sixth embodiment of an automotive seal in accordance with the invention.

FIG. 13 is a perspective view of a seventh embodiment of an automotive seal in accordance with the invention.

FIG. 14 is a cross-sectional view of the seal shown in FIG. 12, taken along the section plane P14 of FIG. 12.

FIG. 15 is a perspective view of an eighth embodiment of an automotive seal in accordance with the invention.

FIG. 16 is a cross-sectional view of the seal of FIG. 1.

FIG. 17 is a diagram showing a seal in accordance with the invention mounted on a concave rebate.

FIG. 18 is a diagram illustrating a first step of a test.

FIG. 19 is a diagram illustrating a second step of a test.

FIG. 20 is a diagram illustrating the test results.

FIG. 21 is a diagram showing the different steps of an embodiment of the method for manufacturing the seal in accordance with the invention.

### DETAILED DESCRIPTION OF THE INVENTION

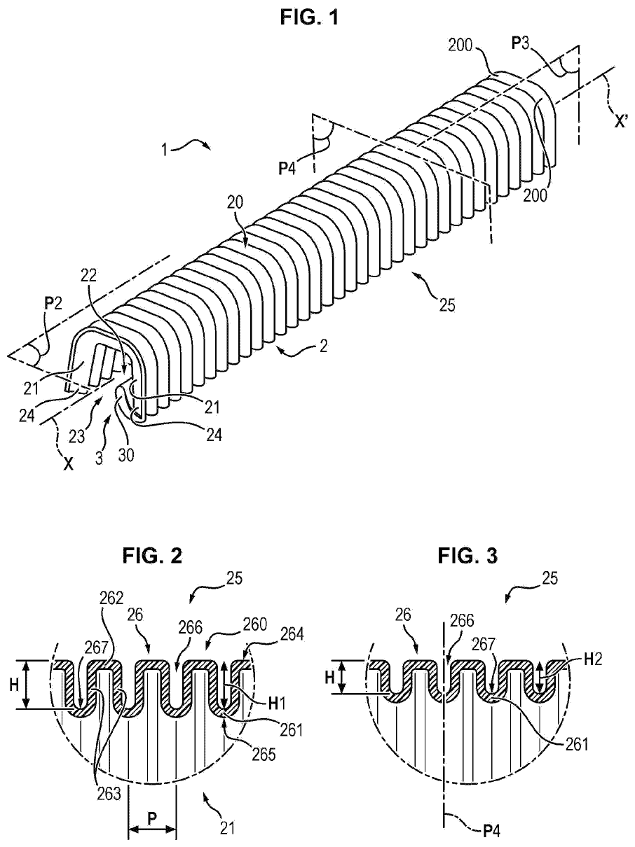

A first embodiment of an automotive seal in accordance with the invention will now be described in connection with FIG. 1.

In this figure, it can be seen that the bendable seal 1 comprises a longitudinal profile 2 made of rigid thermoplastic material and an element made of elastomer material 3, such as a longitudinal sealing lip 30.

The longitudinal profile 2 extends along a longitudinal median axis X-X′. The longitudinal lip 30 extends along the same axis X-X′ and it projects along this profile.

The longitudinal profile 2 has an open cross-section and comprises a bottom 20 and two lateral longitudinal branches 21 which respectively extend from this bottom and on either side of this bottom 20. These two branches 21 and the bottom 20 together form a clamp and thus delimit an open longitudinal cavity 22.

When the longitudinal profile 2 is positioned on a support, such as a rebate, of the motor vehicle, this support (for example the rebate) is received in the open longitudinal cavity 22.

The profile 2 comprises two longitudinal connection regions 200 which respectively extend between the bottom 20 and one of the two branches 21 and between the bottom 20 and the other of the two branches 21.

“Profile of open cross-section” means that the open cavity 22 opens outwards through an aperture 23, formed between the two free ends 24 of the branches 21. In other words, the aperture 23 is located opposite the bottom 20.

In the exemplary embodiment shown in FIG. 1, the longitudinal lip 30 projects from one of the two branches 21, for example from its free end 24, towards the inside of the longitudinal cavity 22.

Although not shown in the figures, it is also possible to have a second longitudinal lip 30 extending from the other of the two branches 21, also towards the inside of the longitudinal cavity 22.

Finally, it is possible to have other longitudinal lips 30 which extend from the bottom 20 towards the cavity 22 or else from any point on the bottom 20 or the branches 21, but towards the outside of the profile 2.

When the seal 1 is in place on a rebate of a motor vehicle, this or these lip(s) participate in ensuring airtightness. The lip(s) 30 which extend towards the inside of the cavity 22 also contribute to retaining the seal 1 on the rebate.

Finally, the profile 2 comprises at least one portion with a corrugated structure 25 which extends at least along one of the two longitudinal connection regions 200 and which, in the exemplary embodiment of FIG. 1, extends over the entire profile 2.

As is better seen in the detailed views of FIGS. 2 and 3 which represent longitudinal sections of the profile 2, the corrugated-structure portion 25 comprises a continuous succession of corrugations 26, without material discontinuity, that is to say without apertures or openings through the profile 2.

As can be seen in FIG. 2, the series of corrugations 26 is made up of a continuous alternation of bridges 260 and junction parts 261. Each bridge 260 comprises a back 262 which is extended by two lateral legs 263, the concavity of the bridge being oriented towards the inside of the longitudinal profile 2, that is to say towards the cavity 22. Each junction part 261 joins the inner end of a leg 263 of a bridge 260 to the inner end of a leg 263 of the neighboring bridge 260.

In the figures, each bridge 260 has a U-shaped section whose two legs 263 are parallel, however other shapes are possible, for example flared or curved legs.

Advantageously, the outer face 264 of the back 262 is flat, as shown in FIG. 2. This makes it easier to attach a coating coextruded with the profile 2, as will be described later.

The inner face 265 of the junction part 261 (that is to say the face facing the cavity 22 of the profile) may be curved. However, advantageously, and although not shown in the figures, it may also be flat.

Preferably, the parallel planes P4 of the different parallel grooves 266 of the corrugations 26 are oriented so as to be perpendicular or substantially perpendicular to the longitudinal axis X-X′ of the profile 2. “Substantially perpendicular” means that the plane P4 forms an angle of less than 10° with the axis X-X′.

The depth H (or height) of a corrugation 26, or more precisely of each bridge 260, measured between the level of the outer face 264 and the outer face 267 of the junction part 261, can be constant over the entire corrugated portion 25 of the profile 2.

However, according to an advantageous variant embodiment, the depth of a corrugation 26 measured at the free end 24 of one of the two branches 21 or of the two branches 21 (see FIG. 2) has a value H1, which is greater than the depth of the same corrugation 26 measured at the bottom 20 of the longitudinal profile 2 and which then has a value H2 (see FIG. 3). In other words, H1 is greater than H2.

In addition, the absence of material discontinuity and the presence of corrugated portions 25 in the branches 21 contributes to preventing the two branches 21 from moving apart from each other and promotes the retention of the seal 1 on the rebate F of a motor vehicle. When the depth H1 is greater than the depth H2, as mentioned above, this effect is further reinforced. Indeed, the quadratic moment of the bridge 260 is increased when the legs 263 are longer.

It should be noted, however, that in other embodiments, H2 could be greater than H1. The values of H1 could also be different in the two branches 21.

Preferably, the pitch P (see FIG. 2) between one groove 266 and the next is constant. Also preferably, this pitch P is equal or almost equal to the depth H (or height) of a corrugation 26.

Preferably, the pitch P is comprised between about 2 mm and 6 mm. Preferably, the depth H of a corrugation 26 is comprised between about 2 mm and 5 mm.

Advantageously, the ratio h/H between the height h of the lateral branch 21 (see FIG. 9) and the height H of a corrugation 26, or more precisely of each bridge 260 is comprised between 2 and 20, more preferably between 3 and 8 or better between 5 and 6.

Preferably, the height h of the lateral branch 21 of the profile 2 is comprised between approximately 10 mm and 40 mm.

Finally, preferably, the width L of the bottom 20 (see FIG. 9) is comprised between approximately 5 mm and 25 mm.

In the exemplary embodiment described in connection with FIG. 1, it can be seen that the two branches 21 are straight and divergent (in other words, they tend to move away from each other from the bottom 20 towards their free end 24).

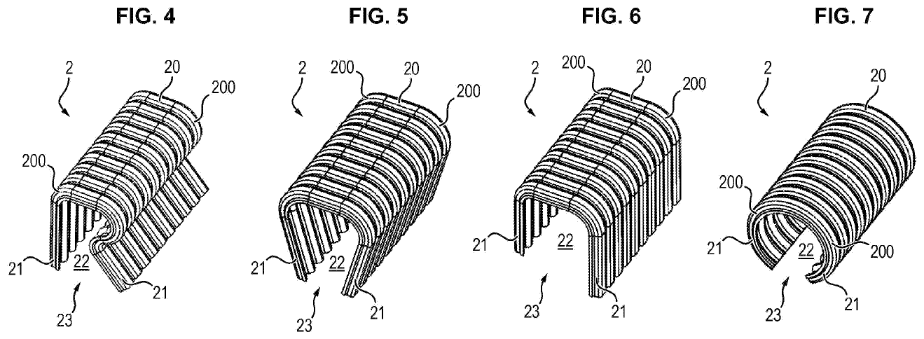

However, other shapes of the profile 2 are conceivable. As a purely illustrative example, it is thus possible to see in FIG. 6, an embodiment in which the two branches 21 are parallel to each other and perpendicular to the bottom 20, in FIG. 5, an embodiment in which the two branches 21 are straight and convergent, in FIG. 4, an embodiment in which the left branch 21 is straight and perpendicular to the bottom 20, while the right branch 21 is curved. In the latter case, the longitudinal profile 2 has an R-shaped cross-section. Such a shape contributes to further reinforcing the clamping effect of the two branches 21.

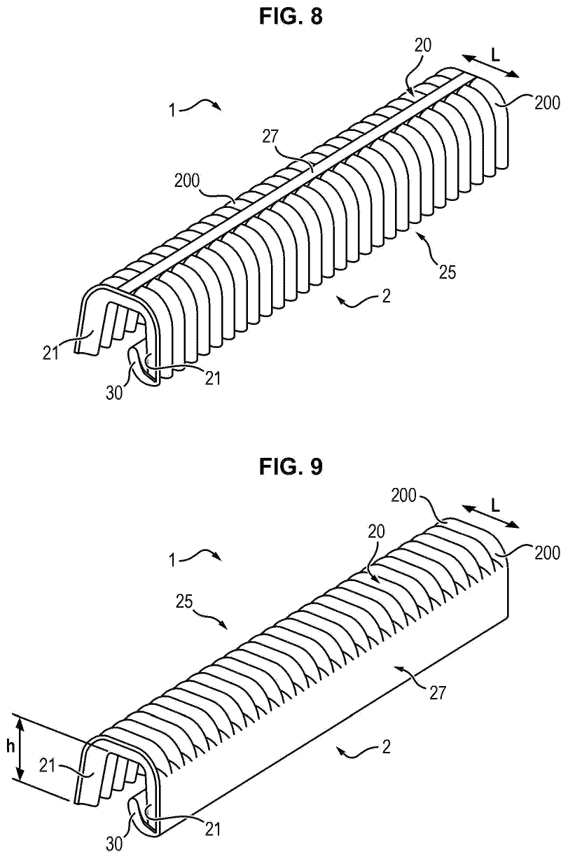

Finally, an embodiment in which the longitudinal profile 2 has a cross-section in the shape of an open O can be seen in FIG. 7. In this case, the bottom 20 and the branches 21 are curved.

It is easily understood that many other cross-section shapes are conceivable for the longitudinal profile 2, without departing from the scope of the invention, provided that this profile has an open cross-section, as defined above.

These different embodiments in which the profile 2 is completely corrugated find a particular application when the profile 2 must be able to bend in all planes.

According to other variant embodiments of the invention which will now be described, the longitudinal profile 2 comprises both at least one portion with a corrugated structure 25 and at least one portion 27 called “smooth”.

“Smooth portion” means that this portion does not have said corrugated structure. In other words, this portion 27 simply has a thickness of the rigid thermoplastic material constituting the longitudinal profile 2 with open cross-section but does not comprise corrugations 26.

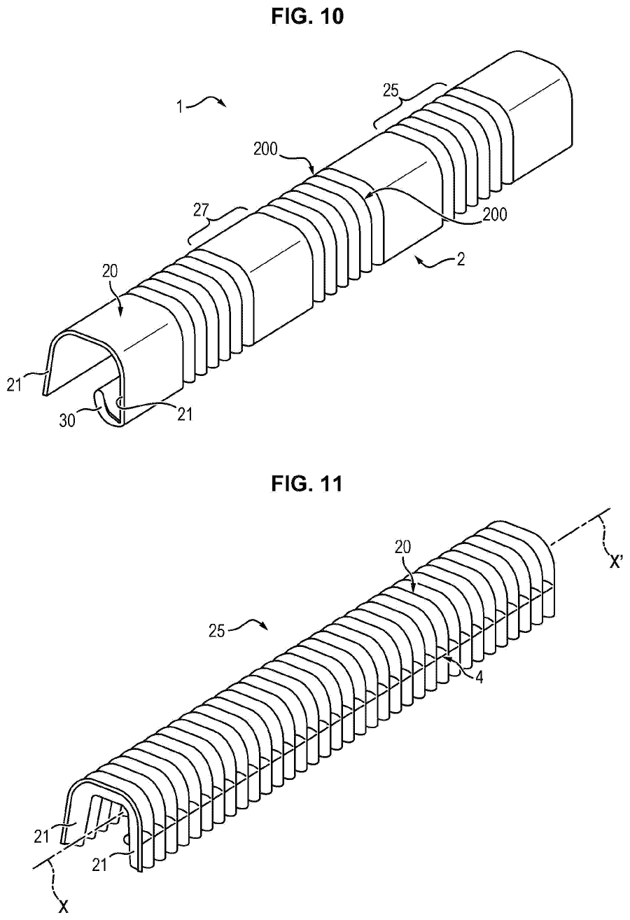

In the exemplary embodiment of FIG. 8, the longitudinal profile 2 comprises a smooth portion 27 which extends over at least part of the width L of the bottom 20 and corrugated-structure portions 25 which extend over the two lateral branches 21.

Such a profile is used for example when the neutral fiber of the profile is required only on the back (bending in the plane P3) such as certain trunk seals for example which possibly further comprise a damping tube on the top of the bottom 20. The plane P3 corresponds to the median longitudinal plane of the profile 2 cutting the middle of the bottom 20.

In the exemplary embodiment of FIG. 9, the longitudinal profile 2 comprises a smooth portion 27, which extends over at least part of the height h of at least one of the two lateral branches 21, here over the entire height h of the two lateral branches 21 but not over the connection region 200 and also comprises a portion with a corrugated structure 25 which extends over at least part of the width L of the bottom 20, here over the entire width L of the bottom 20 and over the region 200.

Such a profile is used for example when a radius grip is required only in the plane P2 or a plane parallel to P2, the neutral fiber of the profile 2 then being on one of the two branches (for example a hood seal). The plane P2 is located at the free ends 24 of the branches 21.

In the exemplary embodiment of FIG. 10, the longitudinal profile 2 comprises an alternation of portions with a corrugated structure 25 and smooth portions 27. In this case, each portion with a corrugated structure 25 extends over the entire cross-section of the profile, in other words over the branches 21 and the bottom 20 and each smooth portion 27 also extends over the entire cross-section of the profile, in other words over the branches 21 and the bottom 20. The alternation of the different portions occurs over the length of the profile.

This type of arrangement allows, for example, to provide portions with a corrugated structure 25 in the parts of the seal 1 intended to match a radius of curvature of a rebate (for example in the corner of a door) and smooth portions 27 in the parts of the seal 1 intended to be opposite a rectilinear part of a rebate (for example a middle part of a vehicle door).

In the exemplary embodiment of FIG. 11, the longitudinal profile 2 comprises a portion with a corrugated structure 25 on the bottom 20 and the branches 21 and this profile 2 is further provided with a longitudinal rib 4 which projects towards the outside of the profile 2.

This longitudinal rib 4 extends along the longitudinal axis X-X′ of the profile 2. In the example shown, this longitudinal rib 4 is disposed on one of the two branches 21. It could also be disposed along the bottom 20.

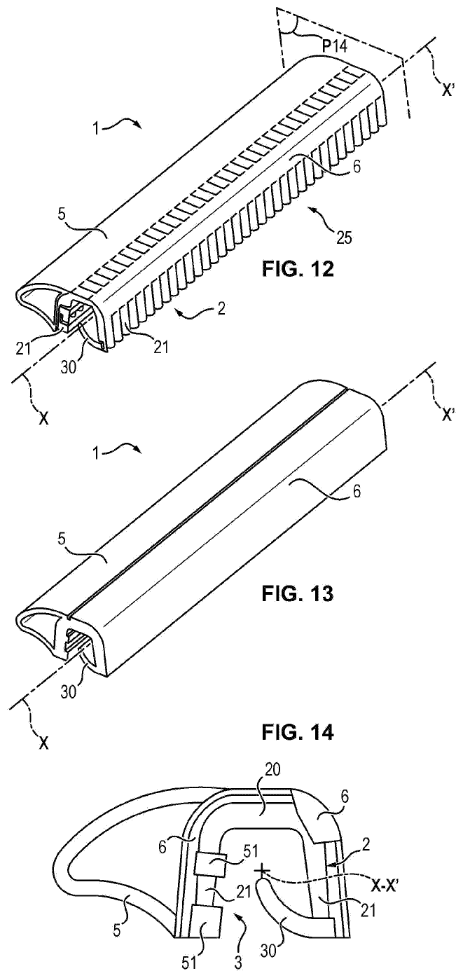

As can be seen in FIGS. 12 and 14, the profile 2 can also be provided with a longitudinal damping tube 5 which projects outwards. This tube 5 extends parallel to the longitudinal axis X-X′ of the profile 2.

This tube 5 can be disposed along a lateral branch 21 or possibly along the bottom 20.

Such a type of seal 1 is intended to be disposed on a rebate located in an aperture of the body of a vehicle, opposite a door-leaf, so that the tube 5 is oriented towards this door-leaf, such as a door, a hood or a trunk. Thus, when this door-leaf is closed, it deforms and flattens the tube 5, which then plays its damping role.

Such a tube 5 may have a cross-section of any shape. In the example shown, this section is substantially triangular.

Advantageously, this tube 5 is coextruded on the profile 2, for example simultaneously with the coextrusion of the sealing lip 3.

It is also possible to coextrude on the profile 2, one or more other elements made of elastomer material which in this case take the form of support pads 51 projecting towards the cavity 22. These pads 51 reinforce the retention of the seal 1 on the support (rebate).

In the embodiments which have just been described, the majority of the corrugated structure 25 of the profile 2 is visible (with the exception of the areas covered by the lip(s) 3 or the tube(s) 5 or the stud(s) 51.

However, it is also possible to cover the longitudinal profile 2, partially (as shown in the embodiment of FIG. 12 or 14) or completely (as shown in the embodiment of FIG. 13) with a coating 6. Such a coating 6 can for example be used to modify the aesthetic appearance of the longitudinal profile 2 by hiding it. This coating 6 is coextruded on the profile 2.

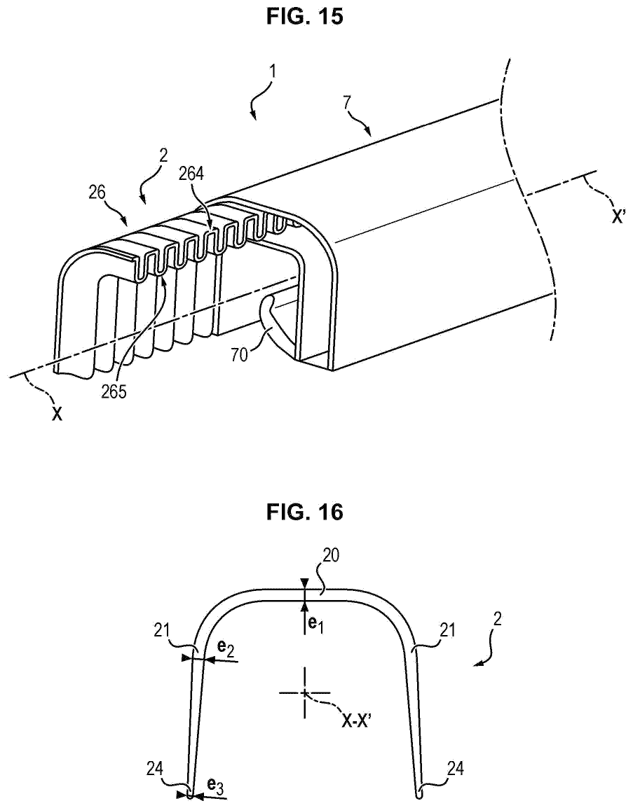

According to another variant embodiment of the invention, shown in FIG. 15, it is possible to have a seal 1, in which the longitudinal profile 2 is covered with a sheathing sleeve 7. More precisely, this sheathing sleeve 7 is coextruded on this profile 2. In this case, the longitudinal sealing lip is integral (made in one piece) with this sleeve 7 and it bears the numerical reference 70. It extends parallel to the longitudinal axis X-X′ of the profile 2 and can project at any point of the sheathing sleeve 7, towards the inside or the outside thereof. If there are support pads, they are also integral (made in one piece) with the sleeve 7.

Such a sleeve 7 could also be provided with a longitudinal damping tube.

In the case of the use of such a sheathing sleeve 7, the profile 2 is preferably configured so that the outer faces 264 of each back 262 of the corrugations 26 are flat and optionally the inner faces 265 of the junction parts 261 of the corrugations 26 are also flat. The sleeve thus adheres better to these flat faces.

Conversely, the use of such a tubular sleeve 7 allows to avoid having any material in the interstices between two bridges 260 of the corrugations 26. This allows to reduce the consumption of the material used for the manufacture of this sleeve 7, to give the finished product (seal 1) a smoother appearance than that obtained with the coating 6 where the material is present in said interstices and finally to have better flexibility than with the coating 6.

It is of course possible to combine over the entire length of a profile 2, as desired, end to end, several of the different embodiments which have just been described in connection with FIGS. 1 and 8 to 15, depending on the use and positioning considered for the seal 1. In all cases, the bendable portion with corrugated structure 25 extends at least along one of the two longitudinal connection regions 200, or even over both.

Finally, advantageously and as shown in FIG. 16, which represents a cross-section of the longitudinal profile 2, the thickness of the thermoplastic material constituting the profile 2 can vary. Thus, for example, this thickness can be less in the two lateral branches 21 than in the bottom 20 (thickness e2 of a branch 21 less than the thickness e1 of the bottom 20) and moreover this thickness can decrease towards the free end of the branches 21 (thickness e3 of this same branch, measured at its free end less than the thickness e2 measured in the middle part of the branch).

This thickness variation may or may not be symmetrical in the two branches.

This variation can allow the position of the neutral fiber of the seal 1 to be modified.

### Materials

Profile 2 is made of rigid thermoplastic material. “Rigid” means a structural material having a Young's modulus greater than 1500 MPa. For example, this material may be a polypropylene (from the polyolefin polymer family), an ABS (Acrylonitrile Butadiene Styrene from the styrenic polymer family), more or less filled for example with talc or glass fibers.

The other elements constituting the seal 1 (lips 30, 70, damping tube 5, support pad 51, longitudinal rib 4, external coating 6, sleeve 7) are made of a flexible elastomer material, preferably a thermoplastic elastomer (TPE), for example a vulcanized thermoplastic (VTP), a thermoplastic styrene (TPS) or a thermoplastic polyolefin (TPO). It is possible to induce porosity in these elements by using a chemical expansion agent or a physical expansion agent (gas microcapsule). These flexible elements may be locally covered by coextrusion of a second lubricated thermoplastic elastomer TPE, in order to reduce the coefficient of friction with surrounding components.

Finally, the aforementioned elements other than the profile 2 can be made of EPDM (ethylene-propylene-diene monomer) type elastomer. In this case, the seal 1 is less easily recyclable but retains its lightness and the economic advantage related to the fact of not using metals.

### Positioning the Profile

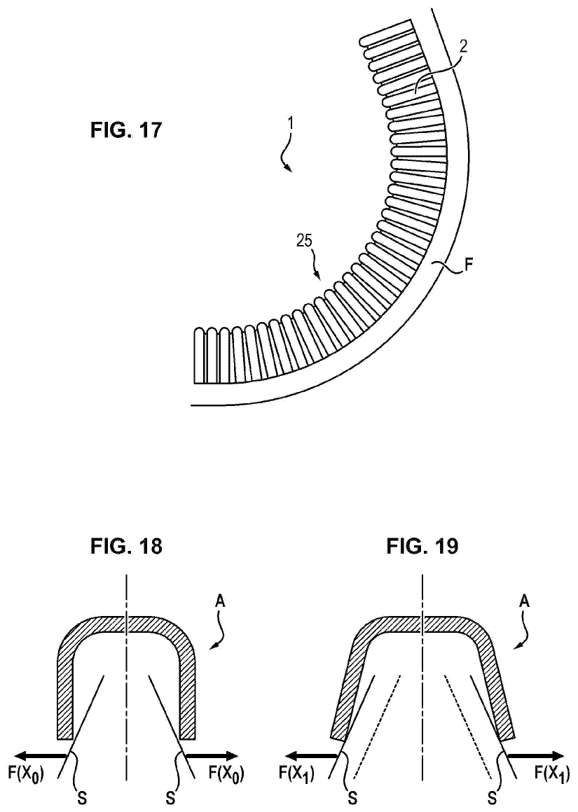

In FIG. 17, the seal 1 is shown positioned on a rebate F of a vehicle, this rebate being concave and having a radius of curvature R. The rebate F penetrates into the cavity 22. Although this is not shown in the figures, the rebate F could also be convex. The corrugated portion 25 of the profile 2 allows to easily bend the seal 1 to follow the radius of curvature R, which can be quite small given the good bending capacity of the seal in accordance with the invention.

### Profile Opening Resistance Tests 2

Comparative tests of the opening resistance of the profile 2 were carried out by comparing different types of profiles.

As can be seen in FIGS. 18 and 19, each tested profile A is disposed astride a support S, the two parts of which are progressively separated respectively to the left and to the right, to pass from an original position X0, in which the profile is not stressed, to a final position X1, in which the profile is stressed so that its two branches tend to move away from each other.

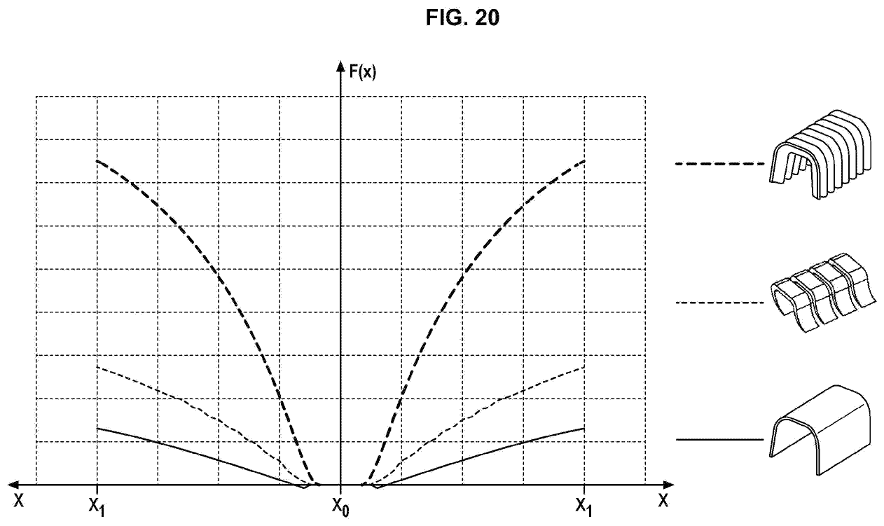

The test results are shown in the graph of FIG. 20, which shows the resistance to separation F(X) in the two aforementioned positions, respectively for a simple, solid U-shaped profile (solid line results), for a prior art profile in the shape of a fishbone (dotted line results) and finally for a profile in accordance with the invention with a corrugated structure (bold dotted line results), all three considered in the same rigid thermoplastic material.

It is observed that a resistance force is obtained when the two branches of the profile open which is approximately 2 times higher for a fishbone profile compared to a simple U-shaped profile and approximately 6 times higher for a profile according to the invention compared to a simple U-shaped profile.

These results demonstrate the synergistic effect which exists between the clamp shape of the profile according to the invention and the corrugated structure and demonstrate that this type of profile is particularly suitable for remaining immobilized on a support (for example a rebate) of a motor vehicle, compared to other profiles of the prior art made from the same material.

### Manufacturing Method

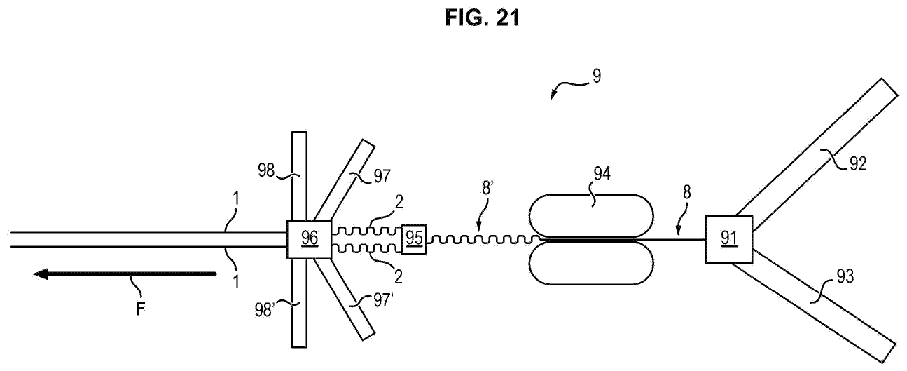

An example of a possible embodiment of the manufacturing method will now be described in connection with FIG. 21. It is implemented in an installation 9.

First, an initial longitudinal profile 8 made of rigid thermoplastic material is extruded using an extruder 91. The profile formed is hollow and of closed cross-section. The extruder is fed from a reservoir 92 of rigid thermoplastic material.

In parallel, it is possible to carry out a coextrusion of at least one other element, using the extruder 91, fed from a reservoir 93 of elastomer material. This other element is for example a sealing lip 30 or a support pad 51, because such elements can be added to the inside of the original profile 8. In the same way, during this step, a coating made of flexible thermoplastic material 6 can be added to the inside and/or outside of the profile 8.

The installation 9 also comprises a machine 94 for forming the corrugated portions 25. The initial profile 8 is passed through this machine, so as to form on at least part of this profile, a portion with a corrugated structure 25. It is thus possible to create on a given profile length, either an entire portion with a corrugated structure 25, or a series of portions with a corrugated structure 25 and smooth portions 27, according to the embodiments described above and to repeat these different patterns, for mass production.

This gives a corrugated profile 8′, which then passes through a cutting machine 95. Such a machine allows to produce an axial cut of the profile with a closed cross-section, so as to obtain two longitudinal profiles 2 with an open cross-section, as described above.

Each of these profiles 2 can then pass through a second die 96, supplied by one or more reservoirs 97, 97′, 98, 98′ of elastomer material, in order to coextrude other elements necessary for the use of the seal 1 on the vehicle, for example external lips, the damping tube 5, the coating 6, the rib 4 or the sheath 7.

In the case where all the elements made of elastomer material have already been formed in the first die 91, it will not be necessary to carry out the second coextrusion step in the second die 96. Conversely, it is possible not to carry out the first coextrusion and to form all the elements made of elastomer material after the cutting step.

The direction of advancement inside the installation 9 is represented by the arrow F.

1. A bendable seal for a motor vehicle, comprising a longitudinal profile configured to be positioned on a support of the motor vehicle, and an element made of elastomer material, selected from a longitudinal sealing lip and a support pad,
the longitudinal profile having an open cross-section and comprising a bottom and two lateral longitudinal branches which respectively extend from the bottom and on either side thereof, such that the bottom and the two branches together form a clamp and delimit a longitudinal cavity, opening opposite the bottom,
the element made of elastomer material projecting from the longitudinal profile towards an inside of the longitudinal cavity,
wherein the longitudinal profile is made of rigid thermoplastic material and comprises, over at least part of the length of the longitudinal profile, a bendable portion with a corrugated structure,
wherein the corrugated-structure portion comprises a continuous succession of corrugations, without material discontinuity, the corrugations being made up of a continuous alternation of bridges and junction parts, each bridge having a back which is extended by two legs, the concavity of the bridge being oriented towards an inside of the longitudinal profile and each junction part joining an inner end of a leg of a bridge to an inner end of a leg of a neighboring bridge,
wherein the corrugated-structure portion extends at least along one of two longitudinal connection regions which respectively extend between the bottom and one of the two lateral longitudinal branches and between the bottom and the other of the two lateral branches of the longitudinal profile,
and wherein the various corrugations comprise parallel grooves which are oriented in parallel planes.

2. The bendable seal for a motor vehicle according to claim 1, wherein the longitudinal profile comprises a smooth portion, free from any corrugated structure.

3. The bendable seal for a motor vehicle according to claim 2, wherein the bendable seal comprises over at least part of a length of the longitudinal profile, an alternation of portions with a corrugated structure and with an open cross-section and of smooth portions with an open cross-section.

4. The bendable seal for a motor vehicle according to claim 2, wherein the bendable seal comprises over at least part of a length of the longitudinal profile, the smooth portion which extends over at least part of a width of the bottom, and corrugated-structure portions which extend over the two lateral branches of the longitudinal profile.

5. The bendable seal for a motor vehicle according to claim 2, wherein the bendable seal comprises over at least part of the length of the longitudinal profile, the smooth portion which extends over at least part of a height of one of the two lateral branches and the corrugated-structure portion which extends over a width of the bottom.

6. The bendable seal for a motor vehicle according to claim 1, wherein the element made of elastomer material is coextruded onto the longitudinal profile.

7. The bendable seal for a motor vehicle according to claim 1, wherein the longitudinal profile comprises a longitudinal damping tube made of elastomer material which projects outwards from the bottom or from one of the two lateral branches and wherein the longitudinal damping tube is coextruded on the longitudinal profile.

8. The bendable seal for a motor vehicle according to claim 1, wherein the longitudinal profile is covered with a sheathing sleeve, coextruded on the longitudinal profile and wherein the longitudinal sealing lip and/or the support pad is made in one piece with the sheathing sleeve.

9. The bendable seal for a motor vehicle according to claim 8, wherein the sheathing sleeve further comprises a longitudinal damping tube which projects outwards from the sheathing sleeve.

10. The bendable seal for a motor vehicle according to claim 1, wherein a depth of the corrugation at a free end of one of the two lateral branches or of both lateral branches is equal to or greater than a depth of the same corrugation in the bottom of the longitudinal profile.

11. The bendable seal for a motor vehicle according to claim 1, wherein a thickness of the thermoplastic material constituting the longitudinal profile is less in the two lateral branches than in the bottom and decreases towards the free end of the branches.

12. The bendable seal for a motor vehicle according to claim 1, wherein the corrugated-structure portion extends over the entire longitudinal profile and wherein the longitudinal profile is provided with a longitudinal rib which projects outwards.

13. The bendable seal for a motor vehicle according to claim 1, wherein an outer face of a back and/or an inner face of a junction part of the corrugations is flat.

14. A method for manufacturing the bendable seal according to claim 1, which comprises the steps of:
extruding a hollow initial longitudinal profile with a closed cross-section, made of rigid thermoplastic material,
forming on at least part of the initial profile, a bendable portion with a corrugated structure, so as to obtain a corrugated profile,
axially cutting the corrugated profile to obtain two longitudinal profiles with an open cross-section,
coextruding an element made of elastomer material, such as a longitudinal sealing lip or a support pad, so as to obtain the bendable seal.

15. The manufacturing method according to claim 14, wherein the coextrusion of the element made of elastomer material is carried out simultaneously with an extrusion of the initial longitudinal profile.

16. The manufacturing method according to claim 14, wherein the coextrusion of the element made of elastomer material is carried out after the step of axially cutting, on the longitudinal profile with open section.

17. The bendable seal for a motor vehicle according to claim 1, wherein the parallel planes of the parallel grooves of the various corrugations are oriented perpendicularly or substantially perpendicularly to the longitudinal axis of said longitudinal profile.

18. The bendable seal for a motor vehicle according to claim 1, wherein the bendable seal is configured to be positioned on a rebate of the motor vehicle.

19. The manufacturing method according to claim 14, wherein the element made of elastomer material is a longitudinal sealing lip or a support pad.
